(19) United States
(12) Patent Application Publication
(10) Pub. No.: US 2009/0102939 A1
(43) Pub. Date: Apr. 23, 2009

(54) APPARATUS AND METHOD FOR SIMULTANEOUSLY ACQUIRING MULTIPLE IMAGES WITH A GIVEN CAMERA

(76) Inventors: Narendra Ahuja, Champaign, IL (US); Manoj Aggarwal, Lawrenceville, NJ (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/244,405

(22) Filed: Oct. 2, 2008

Related U.S. Application Data
(60) Provisional application No. 60/980,889, filed on Oct. 18, 2007.

(51) Int. Cl. H04N 5/228; H04N 5/225

(52) U.S. Cl. 348/222.1; 348/373; 348/E05.024; 348/E05.031

(57) ABSTRACT

An apparatus and method for acquiring multiple images of a given scene. The apparatus allows a standard video imaging camera to simultaneously detect multiple images through the use of reflective surfaces. In at least one embodiment, the multiple images allow for a single image to be created having a high dynamic range. In another embodiment, method for efficiently determining an infrared image is provided.

This application claims the benefit of U.S. Provisional Application No. 60/980,889, filed on Oct. 18, 2007, which is incorporated herein by reference in its entirety.

### TECHNICAL FIELD OF INVENTION

The present invention relates to an imaging apparatus and, more particularly, to an apparatus and method for acquiring multiple images of a field of view, all from a single viewpoint but using different imaging parameters and captured in different parts of a given image sensor at a standard video rate.

### BACKGROUND OF THE INVENTION

A camera capable of acquiring multiple types of images of the same field of view (the extent of the scene captured in the image by the camera) is highly desirable in many applications such as surveillance, scene modeling and inspection. As used herein, the phrase “multiple types of images” is intended to mean the use of different imaging parameters such as the degree of exposure used and the wavelengths captured, just to name two non-limiting examples. As used herein, the phrase “same field of view” is intended to mean that each image depicts the same scene, and the set of locations in all three images where the same scene point is captured is known. It is also desirable to acquire all of the images from a single viewpoint and in real time (e.g., for three dimensional object modeling and display). As used herein, the phrase “real time” is intended to mean substantially at video rates delivered by conventional video cameras, e.g., substantially at 30 frames/second or faster. Finally, it is also desirable that the image generation preserves image quality such as resolution (i.e., pixel density of sensor), and that the camera design is easy to implement and use.

Many efforts have been made to meet various of the aforementioned basic objectives of: (i) single field of view, (ii) single viewpoint, (iii) real time video rate acquisition, and (iv) high image quality, (v) simplicity of implementation and use. Most work on acquiring multiple images from the same viewpoint has involved beam splitters of different types. With respect to different types of images, most work has focused on capturing different degrees of exposure, different primary colors, and different ranges of the incident light spectrum such as visible and infrared wavelengths. Many of these methods have been involved in faithfully acquiring the entire range of brightness values encountered in real-world scenes, which is quite large. A conventional digital camera sensor captures only 8-bits (256 levels) of brightness information, called its dynamic range, which is typically inadequate and results in an image with many areas which are either too dark (under saturated or clipped) or too bright (oversaturated).

The basic idea of high dynamic range imaging is to acquire multiple images using different exposure settings, thus capturing different portions of the scene brightness range, each within the limited sensitivity range of the sensor; these images are then combined to cover each portion of the brightness range captured properly in a given image. For example, one image may be obtained using a shorter exposure time which will avoid oversaturation while imaging bright parts of the scene. Another image may be obtained using a longer exposure time which will allow the dark parts of the scene to be imaged well and avoid underexposure. The high dynamic range imaging methods can be divided into six different classes, according to whether the multiple images are acquired sequentially (which adversely affects acquisition rate as well as capability to capture moving objects) or in parallel (which facilitates faster acquisition, e.g., video rate or higher). The parallelism is achieved by trading spatial resolution, e.g., by fabricating each pixel as a set of micropixels having different sensitivities and thus different exposures, or by splitting and directing the incident light beam to multiple ordinary sensor elements. The traditional beam splitters introduce additional lens aberrations because many of them are made of glass with finite thickness and refract light (except pellicle beam splitters) which must be compensated for using special lenses. Furthermore, the number of beam splitters required may be too bulky to fit in the available space between the lens and the sensor. Both of these features increase design size and complexity. The different exposure levels are achieved by changing the shutter speed or aperture size (each of which is easily achieved). Alternatively, exposure level can be controlled by putting a filter in front of the sensor pixels, designing different pixels with different light sensitivities, or even by measuring the rate at which a pixel accumulates charge, all three of which require a special sensor design. These methods are summarized below.

1. Sequential exposure change: The exposure setting is altered by changing the aperture size, shutter speed, or transmittance of a filter placed between the sensor and the scene. This method is suitable only for static scenes.

2. Active camera/sensors: This method is the same as the preceding method except that the change in exposure setting is performed by internal circuitry and the acquired multiple images are combined to form the dynamic range image within the camera electronics.

3. Multielement Pixels: Each pixel consists of multiple, independent subpixels having different photosensitivities, acquiring the desired multiple images in parallel. The construction of the high dynamic range image is performed either on the sensor chip or externally. This requires a complex sensor. Further, the need for multiple subpixels increases the overall pixel area, thus increasing pixel size and reducing pixel resolution achieved in comparison with a conventional sensor.

4. Adaptive pixel exposure: Each pixel senses the time it takes for the pixel to saturate, which is then converted into an equivalent intensity value. Time is recorded quite precisely, and therefore the dynamic range of the captured image is high. However, the need for computation translates into need for pixel area and therefore lower resolution. Further, the time taken by the darkest regions to saturate increases the worst case image acquisition time, thus increasing sensitivity (e.g., blur) due to scene motion.

5. Spatially varying exposure: The image pixels are divided into multiple groups where each group uses a different exposure level. A group may consist of selected rows, e.g., odd or even rows, or a set of neighboring pixels may be bundled and a group then may consist of one set of corresponding pixels from the bundles. This method is thus analogous to method 3 above except that the pixels in a given sensor are grouped instead of fabricating sensors with subpixels and associated processing electronics. The resulting high dynamic range image has a lower resolution than the original sensor.

6. Multiple sensors: The incoming light is split into multiple beams and directed to multiple sensors, each using a different exposure level. Thus, it achieves the same result as methods 1 and 2, but in parallel instead of sequentially. Multiple beams are usually created by using beam splitters. Many of the prior art methods differ in the type of beam splitter used and the exposure control method used. The present invention belongs to this class.

The relative performance of these methods with respect to the objectives is summarized in Table 1. The performances of the six classes of existing methods and the current invention are compared. All of the methods meet objectives (i-ii). Their performance with respect to objectives (iii-v) is summarized in Table 1. None of the methods except the current invention meet all of the objectives. (Image resolution refers to pixel density on the sensor, not the total number of pixels in the image).

TABLE 1

| | Acquisition | Image | Simplicity/ |
|---|---|---|---|
| | Rate | Resolution | Usability |
| Sequential Exposure Change | Low | High | High |
| Active Camera/Sensors | Low | High | Low |
| Multiple Sensor Elements | High | Low | Low |
| Per Pixel | | | |
| Adaptive Pixel Exposure | Low | High | Low |
| Spatially Varying Exposure | High | Low | Low |
| Multiple Sensors | High | High | Low |
| Current Invention | High | High | High |

As Table 1 shows, one drawback of the prior art is that it fails to provide an apparatus or method for acquiring images consistent with objectives (i-v).

### SUMMARY OF THE INVENTION

In view of the foregoing, it is an object of the present invention to overcome these and other drawbacks of the prior art.

Specifically, it is an object of the invention to provide a method and apparatus for acquiring multiple images of the scene.

It is another object to be able to capture the multiple images from a single viewpoint.

It is another object to be able to select the optical properties of the individual images, e.g. the exposure settings used.

It is another object to provide multiple images having different spectral selectivity, e.g., ability to select the wavelengths to be captured from the entire spectrum, such as the visible spectrum (grayscale, red, green, blue), and infrared.

It is another object to provide multiple images on the same sensor.

It is another object to provide the locations of any scene point in all images.

It is another object to process the multiple images to integrate the diverse information present in them.

It is another object that the apparatus is easily attachable to a given camera.

Together, these objects help meet the five objectives, (i-v), mentioned earlier. In order to accomplish a part of these and other objects of the invention, there is provided an imaging apparatus as described in the following. The complete apparatus is shown in FIG. 1. Whenever the meaning is clear from the context, we refer herein to both optical and spectral properties of the light as simply optical properties, for brevity.

The first major component of the apparatus consists of a configuration of multiple mirrors attached at, and extending in front of, the entrance pupil of a conventional camera. The mirror system reduces the field of view of the apparatus from being the entire physical space in front of the camera to a part of it. This part is viewed directly by the camera. In addition, multiple images of this part are also formed by the mirror configuration, each being the cumulative result of reflections from one or more of the mirrors. The arrangement of the mirrors determines the size and shape of the directly viewed part of the space imaged, as well as the number of its images formed. Each such image acts as a separate virtual field of view, in addition to the directly viewed part of the field of view. The directly viewed part of field of view is imaged on a portion of the image sensor (array of light sensing elements) inside the camera. Each virtually viewed part of the field of view is imaged on a different portion of the sensor. The sensor is thus partitioned into multiple portions, each of which contains an image of the same, selected part of the field of view. The pixel locations where a specific scene point appears in all images are known because the same (real or virtual) field of view is captured in each image by a known mirror configuration.

The second major component of the apparatus involves selecting the optical properties of the mirrors so that the different images have the desired properties. These properties determine the modifications made to the light incident on the mirrors from a scene point, before the light is captured to form multiple images in different portions of the sensor. The image value at any pixel is the cumulative result of the series of transformations (such as reflections and absorptions) that the light reaching the pixel has undergone after leaving the corresponding scene point. The pixel values within different images can thus be controlled by controlling the optical properties of the mirrors. The choice of mirror properties thus serves as a way of selecting the contents of the different images. As used herein, reference to selecting mirrors means selecting their spatial configuration as well as optical properties.

### BRIEF DESCRIPTION OF THE DRAWINGS

FIG. 1 is a schematic diagram showing the major components of one embodiment of the invention.

FIG. 2 is a schematic diagram of a first embodiment mirror configuration according to the present invention, consisting of a single mirror that generates two images of the same field of regard.

FIG. 3 is a schematic diagram of a second embodiment mirror configuration according to the present invention, consisting of two mirrors that generate four images of the same field of regard.

FIG. 4. is a schematic block diagram of the different stages of the present invention.

### DETAILED DESCRIPTION OF THE VARIOUS EMBODIMENTS

For the purposes of promoting an understanding of the principles of the invention, reference will now be made to certain embodiments thereof and specific language will be used to describe the same. It will nevertheless be understood that no limitation of the scope of the invention is thereby intended, such alterations, further modifications and further applications of the principles of the invention as described herein being contemplated as would normally occur to one skilled in the art to which the invention relates.

One embodiment of the invention is a box containing mirrors that attaches to the front of a given camera at its entrance pupil and extends in front of the camera. Only a part of the complete field of view of the camera is imaged by the invention. Multiple images of this part are formed in different portions of the same, single sensor. The properties of the mirrors are chosen according to the desired properties of the multiple images formed.

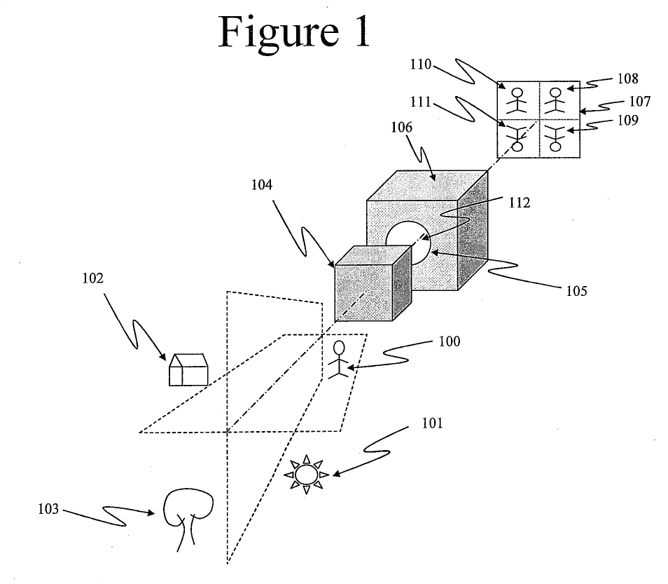

As shown in FIG. 1, a camera box 106 includes an entrance pupil 105 located at the front face of the camera box 106. For simplicity of description, the reversals in image formation by conventional cameras are disregarded, and the images formed are shown upright throughout the present disclosure. A mirror box 104 is positioned in front of the camera box 106 and, in some embodiments, attached thereto. In this embodiment, the field of view of the entrance pupil 105 is blocked except in the top right quarter 112, so that it allows light only from a scene section 100 of the overall field of view (100-103) to pass through. The mirror box 104 is configured to project multiple images of the scene section 100 to be imaged multiple times (for example 108-111) on the sensor 107 of the camera 106. The configuration and properties of the mirrors within the mirror box 104 can be chosen to select the desired properties of the individual images 108-111.

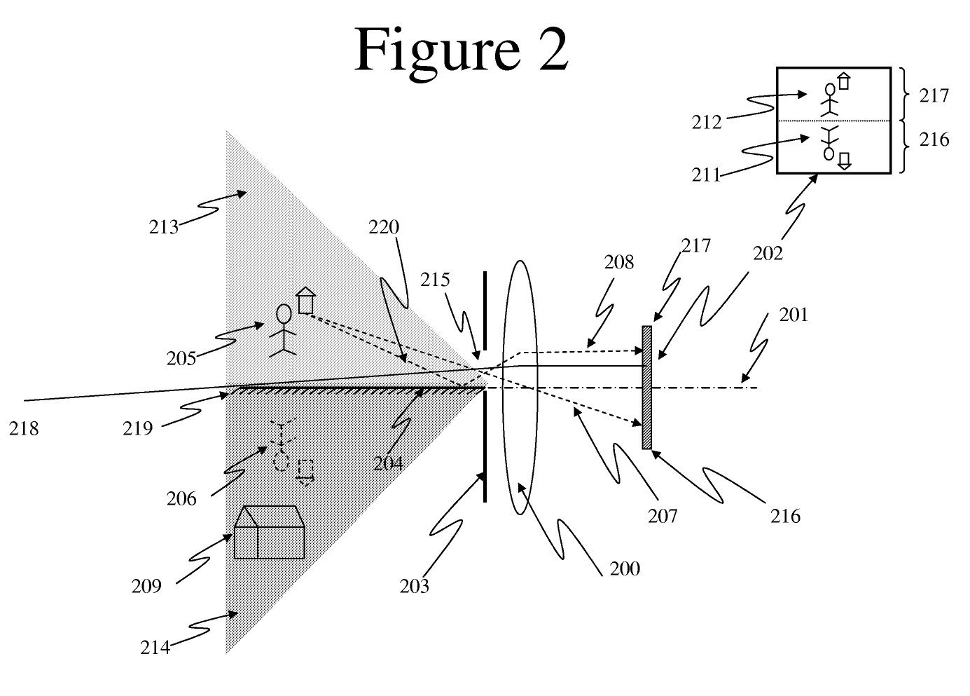

FIG. 2 schematically illustrates a first embodiment imaging apparatus for the first component of the current invention—capturing multiple images of a part of the visual field on the sensor of a given camera. It captures one half 213 (the half above the hatched line 201) of the field of view 213/214 to create two images on two halves 216 and 217 of the sensor 202. A single planar mirror surface 204 extends in front of the entrance pupil 203/215 of a given camera system consisting of lens 200 and sensor 202 (the entrance pupil, usually centered at the optical axis, should be externally accessible for the attachment of the mirror box of the current invention). The mirror surface 204 is preferred to contain the entrance pupil 203/215 and the optical axis 201 of the camera, thus splitting the field of view into two halves 213 and 214. The entrance pupil consists of a bottom part 203 which is below the mirror 204, and a top part 215 which is above the mirror 204. The bottom part 203 of the entrance pupil is blocked so no light enters the lens 200 from the bottom half 214 of the field of view. As a result, an object, such as 209, lying in the bottom half 214 of the field of view is not imaged by the sensor 202. Light from the top half 213 of the field of view enters the camera from the top part 215 of the pupil. It will be appreciated that some light from the bottom half 214 of the space can also reach the sensor 202, namely, from objects that are in the lower half 214 of the field of view but far enough so that light, 218, from them can escape the mirror edge 219 and enter the unblocked pupil. The resulting image area on the sensor 202 overlaps with that due to the light from the top half 213, thus mixing different images. The area where images mix decreases as the length of the mirror 204 increases, the distance of the object from the camera decreases, or the pupil size decreases. This overlap area can be cut out to produce a final image with a smaller visual field but without image overlap. In view of the availability of this option for correction, henceforth we will neglect the light entering the pupil from the bottom half.

The light incident from the top half 213 of the field of view enters the pupil in two ways—directly as well as after reflection from the mirror 204. The directly entering light, such as ray 207, forms an image, which occupies only bottom half 216 of the sensor 202. The light entering after reflection, such as ray 208, gets reflected by the mirror 204 and then enters the top half 215 of the pupil. Effectively, an image 206 of the top half 213 of the space, which forms behind (under) the mirror 204, replicates the top half 213 and acts as a virtual field of view. The reflected light (as if from the virtual objects) forms an image on the remaining half 217 of the sensor 202. Thus, the sensor 202 now has two identical images 211 and 212 formed on its two halves, each capturing the top half 213 of the camera's field of view. Each scene point appears at a known pixel in each image. The bottom half 214 of the camera's field of view is sacrificed to obtain two images of the top half 213.

In the second component of the current invention, the optical properties of images 211 and 212 may be selected by replacing the simple planar mirror 204 by a partially reflective surface, which reflects a fraction α of the light 220 incident on it and absorbs the rest. Such partially reflective mirrors are standard commercial products and well known in the art. The light, such as ray 207, directly entering the unblocked half 215 of the pupil reaches the sensor half 216 without any loss, whereas light, such as ray 208, reflected by mirror 204 and then reaching the other half 217 of the sensor 202 is reduced to the fraction α of the amount of light 220 incident on mirror 204. In this example, the two images 211 and 212 are formed on two halves of the original camera sensor 202, showing the top half field of view 213. However, since the amounts of light from a scene point incident directly on the pupil and incident on the mirror 204 are equal, the reflected amount of light reaching the second half 217 of the sensor 202 is a times the amount of direct light reaching the first half 216. The brightness of the image formed on the second half 216 of the sensor 202 is proportional to α. By controlling the value of α, the second-half image can be made less bright than the first-half image. By increasing the exposure time to a sufficiently large value, and ensuring that each scene point is properly exposed in at least one of the images, the two images can be processed to obtain a high dynamic range image. For example, the properly exposed parts of each of the two images can be selected, transferred to compose a new output image, and normalized, leaving behind the over and underexposed parts. The output image then is the desired single high dynamic range image in which all parts are properly exposed.

Another example of the imaging apparatus for selecting the optical properties of the mirrors is described below. The simple planar mirror 204 is replaced by a partially reflective surface, which reflects the visible part of the light, such as ray 220 incident on it, and absorbs the infrared part. This can be achieved by using a combination of simple reflective mirrors and infrared filters both of which are standard commercial products known in the art. The light, such as ray 207, entering the unblocked half 215 of the pupil directly reaches the sensor half 216 without any loss (thus consisting of both visible and infrared portions), whereas light 208 reflected by the mirror 204 and reaching the other half 217 of the sensor consists of only the visible portion of the incident light, without the infrared portion. In this example, the two images 211 and 212 are formed on the two halves of the sensor 202, each showing the top half 213 of the field of view. Image 211 contains both visible and infrared portions, whereas 212 is only a visible image. These two images can be processed to obtain desired outputs, e.g., separate visible and infrared images. Since 212 is already a visible image, the infrared image can be obtained simply by subtracting corresponding pixel values of image 212 from those of image 211.

This basic apparatus of the first and second components, illustrated by FIG. 2, may be altered and combined to obtain different additional embodiments of the current invention.

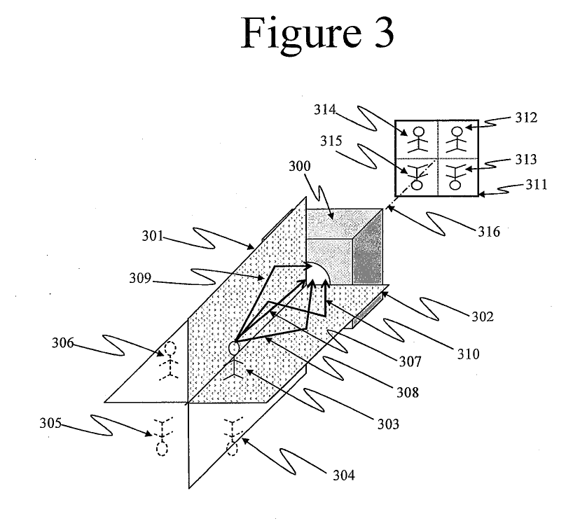

FIG. 3 demonstrates an example of forming more than two images by the current invention. It shows two planar reflecting surfaces 301 and 302. The mirrors 301 and 302 are preferably placed such that they are mutually perpendicular (intersect at an angle of 90 degrees), extend in front of the pupil, and their line of intersection coincides with the optical axis 316. Like the embodiment of FIG. 2, each mirror 301/302 divides the field of view into two parts. Together, the two mirrors 301/302 divide the field of view into quarters 303, 304, 305 and 306. Three quarters of the entrance pupil are blocked so that so that light from quarters 304, 305 and 306 cannot enter the pupil. Only light from quarter 303 goes through the unblocked portion of the pupil, which is the only portion of the pupil visible in FIG. 3. (As explained with respect to FIG. 2, we again neglect the light entering the pupil from the other quarters.) Light, such as ray 307, reaching the pupil directly forms an image 315 on only one quarter of sensor 311. Light, such as ray 309, entering the pupil after one reflection from mirror 301 forms an image 313 on another quarter of the sensor 311. Light, such as ray 308, entering the pupil after one reflection from mirror 302 forms an image 314 on a third quarter of the sensor 311. Finally, light, such as ray 310, entering the pupil after two reflections, from mirrors 301 and 302, forms an image 312 on the remaining fourth quarter of the sensor 311. The sensor 311 now contains a total of four images, formed on its four quarters, each capturing the same quarter of the camera's field of view.

An example of selecting the optical properties of the individual images 312-315 is described below. The simple planar mirrors 301 and 302 of FIG. 3 are replaced by partially reflective surfaces which are known in the art and commercially available. The mirrors form four images of the same quarter of the field of view on the four quarters of sensor 311. Mirror 301 reflects a fraction α of the light, such as ray 309, incident on it and absorbs the rest. Mirror 302 reflects a fraction β of the light, such as ray 308, incident on it and absorbs the rest. The light, such as ray 307 directly entering the unblocked portion of the pupil, reaches sensor 311 without any loss. The amounts of reflected light reaching quarters 313, 314 and 312 of the sensor are, respectively, proportional to the fractions α, β and α.β of the amount of light directly reaching sensor quarter 315. As an example, α and β values can be chosen to regulate the amounts of light reaching their corresponding sensor quarters, so as to avoid over and underexposure of each scene point in the quarter of the field of view involved, in at least one of the four images 312-315. These four images 312-315 can be processed, e.g., to construct a high dynamic range image. For example, the properly exposed parts of each of the four images can be selected, transferred to compose a new output image, and normalized, leaving the over and underexposed parts unused. The output image then is the desired single high dynamic range image in which all parts are properly exposed. This embodiment allows the use of more exposures than the high dynamic range embodiment with two mirrors shown in FIG. 2, and thus provides greater flexibility at constructing the output high dynamic range image.

Another example of selecting the spectral properties of the individual images 312-315 is described below. In this case, the simple planar mirrors 301 and 302 are replaced by a combination of reflective surfaces and color filters. Light, such as ray 307 directly entering the pupil reaches and forms an image consisting of all three colors as well as the infrared component on quarter 315 of sensor 311. Mirror 301 is chosen (using a simple red filter) so that it reflects the red component of the light incident on it, such as ray 309, and absorbs the rest. The reflected red light forms the red component image 313 on one sensor 311 quarter. Mirror 302 reflects (using a simple green filter) the green component of the light, such as ray 308, incident on it and absorbs the rest, which forms the green component image 314 on another sensor 311 quarter. Light, such as ray 310, which is the result of consecutive reflections from both mirrors 301 and 302, has lost all three of red, green and blue components, and therefore contains only the infrared portion of the light, forms an image 312 on sensor 311. The four images 312-315 can now be processed to form four different images of the scene, each capturing the three primary colors—red, green and blue—or infrared. For example, the four values at the same pixel in all four quarters of the sensor 311 can be combined (e.g., added, subtracted, etc.) to calculate the red, green, blue and infrared values at that pixel, thus obtaining four constituent images of the scene in the quarter field of view being imaged.

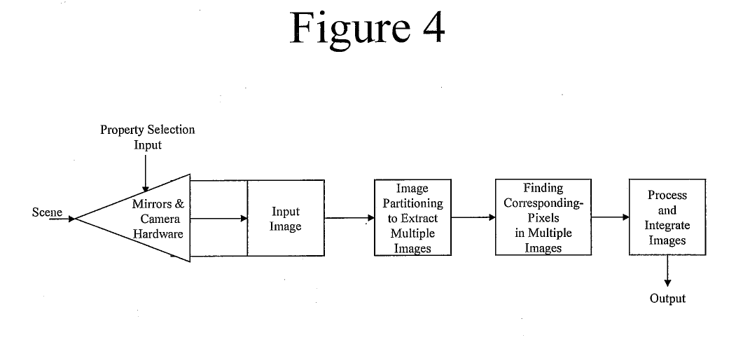

FIG. 4 is a block diagram of the various stages involved in multiple image generation according to one embodiment of the present invention. All of the operations of this step are completed in the image buffer. The mirrors and camera hardware are exposed to the scene to be imaged and the property or properties to be used in the imaging is input to the system. The camera inputs the captured image to the image buffer, the image is partitioned to extract multiple images, corresponding pixels in the multiple images are identified, and the pixel data may be process in a variety of ways as discussed above prior to being output.

In a preferred embodiment, it was found to be effective to utilize the following materials:

(1) Sony Camcorder

(2) A standard Compound Lens

(3) Fiber Alignment Stages, available from New Focus, Inc., 2630 Walsh Ave., Santa Clara, Calif. 95051-0905

(4) Two plane mirrors, available from Edmund Scientific, 60 Pearce Ave., Tonawanda, N.Y. 14150.

The foregoing is a description of the preferred embodiments of the present invention. Various modifications and alternatives within the scope of the invention will be readily apparent to one of ordinary skill in the art. Examples of these include but are not limited to: changing the mirror configuration to obtain different numbers, shapes and sizes of the field of view imaged, changing the optical properties of the mirrors used to form each image (reflectances used, wavelengths selected, etc.), and changing the resolution of the individual image detecting means (sensor).

What is claimed is:

1. An apparatus for use with an image detection device to acquire multiple images of a scene, said image detection device having an entrance pupil to receive light radiating from a field of view, said image detection device further having at least one sensor operable to create an image based on light entering said entrance pupil, said apparatus comprising:
a housing having a first opening and a second opening, said first opening adapted to be juxtaposed with said entrance pupil, said second opening facing said scene; and,
at least one reflective surface located within said housing, such that a portion of said field of view is obstructed;
wherein said at least one sensor receives light radiated from said scene and traveling through said second and first openings, wherein a first portion of said sensor receives light directly radiated to said entrance pupil, and a second portion of said sensor received light reflected by said at least one reflective surface.

2. The apparatus of claim 1, wherein said housing is fixedly connected to said image detection device.

3. The apparatus of claim 1, wherein said housing includes one reflective surface and, said sensor produces two images of said scene.

4. The apparatus of claim 3, wherein said one reflective surface at least partially absorbs a component of the light radiated from said scene.

5. The apparatus of claim 4, wherein said component of light is infrared rays.

6. The apparatus of claim 1, wherein said housing includes a first reflective surface and a second reflective surface, said first reflective surface being substantially orthogonal to said second reflective surface.

7. The apparatus of claim 6, wherein said first reflective surface at least partially absorbs a component of the light radiated from said scene.

8. The apparatus of claim 7, wherein said component of light is infrared rays.

9. A process for producing multiple images of a scene to increase the dynamic range of an image of said scene, comprising the acts of:
(a) providing an image sensing device having an entrance pupil and an image sensor, said entrance pupil defining a field of view of said image sensing device;
(b) partially obstructing a portion of said field of view, wherein an unobstructed portion of said field of view defines a scene;
(c) using said image sensor to create a first image of said scene from light reflected off of at least one reflective surface; and,
(d) using said image sensor to create a second image of said scene from light not reflected off of said at least one reflective surface.

10. The process of claim 9, further comprising the acts of:
(e) storing said at first image and said second image; and,
(f) combining said first and second images.

11. The process of claim 9, further comprising the act of:
(e) providing a housing having a first opening and a second opening, said first opening constructed and arranged to be coupled to said image sensing device adjacent to said entrance pupil.

12. The process of claim 11, wherein step (e) comprises fixedly connecting to said housing to said image sensing device.

13. The process of claim 9, wherein said at least one reflective surface at least partially absorbs a component of light.

14. The process of claim 13, wherein said component of light is infrared rays.

15. A process for producing multiple images of a single scene comprising the acts of:
(a) providing an image detecting device having an entrance pupil and an imaging sensor, said entrance pupil defining a field of view;
(b) dividing said field of view into at least two regions, wherein one of the at least two defines a scene;
(c) creating at least two images of said scene, wherein one of said at least two images is based on light received by said imaging sensor that is reflected off of at least one reflective surface; and,
(d) storing said at least two images.

16. The process of claim 15, further comprising the act of:
(e) combining at least two of said at least two images.

17. An apparatus for use with an image detection device having an entrance pupil and an imaging sensor, said entrance pupil defining a first field of view, said apparatus comprising:
a housing having a first opening and a second opening, said first opening constructed and arranged to be coupled to said image detection device adjacent to said entrance pupil, said housing defining a second field of view that is smaller than said first field of view, said second field of view encompassing a scene of interest; and,
at least one reflective surface positioned within said housing,
wherein said at least imaging one sensor detects light radiated directly from said scene to said entrance pupil and also light entering said entrance pupil after being affected by said at least one reflective surface, thereby creating at least two images of said scene.
